(19) United States
(12) Patent Application Publication
(10) Pub. No.: US 2012/0030596 A1
(43) Pub. Date: Feb. 2, 2012

(54) USER INTERFACE

(76) Inventor: David H Hanes, Loveland, CO (US)

(21) Appl. No.: 13/260,353

(22) PCT Filed: Oct. 5, 2009
(86) PCT No.: PCT/US09/59539

§ 371 Date: Sep. 25, 2011

(51) Int. Cl. G06F 3/048

(52) U.S. Cl. 715/765

(57) ABSTRACT

A method for rendering a user interface including selecting a user profile to be loaded as the user interface in response to a user accessing a digital display device, identifying and loading one or more content associated with the user profile, and rendering the user interface to include the content associated with the selected user profile for display on the digital display device.

### BACKGROUND

When viewing a digital display device, a user couples the digital display device to one or more devices. The user then accesses one or more files on one or more of the devices and proceeds to load the files onto the digital display device through one or more connection ports available on the digital display device. Once the files have been loaded onto the digital display device, the files can be rendered for the user to view on the digital display device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the embodiments.

FIG. 1 illustrates a machine coupled to a digital display device and one or more input devices according to an embodiment of the invention.

FIG. 2 illustrates a block diagram of an interface application selecting a user profile to load as a user interface and identifying one or more content associated with the user profile according to an embodiment of the invention.

FIG. 3 illustrates a block diagram of an interface application rendering a user interface for display on a digital display device in response to a selected user profile according to an embodiment of the invention.

FIG. 4 illustrates a user creating or editing one or more user profiles according to an embodiment of the invention.

FIG. 5 illustrates a machine with an embedded interface application and an interface application stored on a removable medium being accessed by the machine according to an embodiment of the invention.

FIG. 6 is a flow chart illustrating a method for rendering a user interface according to an embodiment of the invention.

FIG. 7 is a flow chart illustrating a method for rendering a user interface according to another embodiment of the invention.

### DETAILED DESCRIPTION

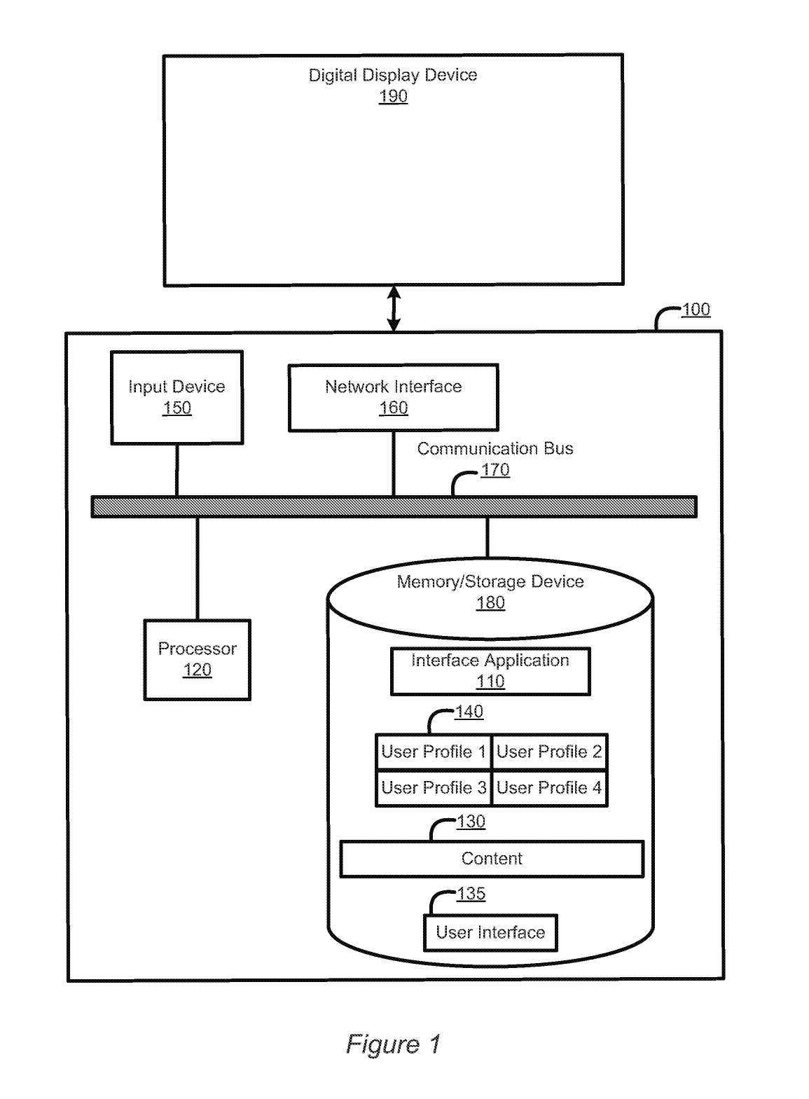

FIG. 1 illustrates a machine 100 coupled to a digital display device 190 and one or more input devices 150 according to an embodiment of the invention. In one embodiment, the machine 100 is a digital photo frame. In other embodiments, the machine 100 is a desktop, a laptop, a server, and/or any device that a digital display device 190 is coupled to. As illustrated in FIG. 1, the machine 100 is coupled to the digital display device 190 and includes a processor 120, one or more input device 150, a memory/storage device 180, a network interface 160, and a communication bus 170 for the machine 100 and/or one or more components of the machine 100 to communicate with one another.

Further, as illustrated in FIG. 1, the memory/storage device 180 stores an interface application 110, one or more user profiles 140, one or more content 130, and a user interface 135. In other embodiments, the machine 100 includes additional components and/or is coupled to additional components in addition to and/or in lieu of those noted above and illustrated in FIG. 1.

As noted above, the machine 100 includes a processor 120. The processor 120 sends data and/or instructions to the components of the machine 100, such as one or more input devices 150, the memory/storage device 180, the digital display device 190, and the interface application 110. Additionally, the processor 120 receives data and/or instruction from components of the machine 100, such as the interface application 110.

The interface application 110 is an application which can render a user interface 135 for display on the digital display device 190. In rendering the user interface, the interface application 110 selects one of the user profiles 140 to be loaded as the user interface 135 in response to a user accessing the digital display device 190.

Once the interface application 110 has selected a user profile 140, the interface application 110 can proceed to identify and load one or more content 130 associated with the selected user profile 140 as part of the user interface 135. The interface application 110 will then render the user interface 135 to include the content 130 associated with the selected user profile 140 for display on the digital display device 190.

The interface application 110 can be firmware which is embedded onto the machine 100. In other embodiments, the interface application 110 is a software application stored on the machine 100 within ROM or on a storage device 180 accessible by the machine 100 or the interface application 110 is stored on a computer readable medium readable and accessible by the machine 100 from a different location. Additionally, in one embodiment, the storage device 180 is included in the machine 100. In other embodiments, the storage device 180 is not included in the machine, but is accessible to the machine 100 utilizing a network interface 160 included in the machine 100. The network interface 160 may be a wired or wireless network interface card.

In a further embodiment, the interface application 110 is stored and/or accessed through a server coupled through a local area network or a wide area network. The interface application 110 communicates with devices and/or components coupled to the machine 100 physically or wirelessly through a communication bus 170 included in or attached to the machine 100. In one embodiment the communication bus 170 is a memory bus. In other embodiments, the communication bus 170 is a data bus.

As noted above, the interface application 110 renders a user interface 135 for display on the digital display device 190. The user interface 135 is a rendered output of the digital display device 190 which the user can view and interact with. Additionally, the user interface 135 can include one or more images, text, and/or videos. Further, the user interface 135 is rendered for display on the digital display device 190.

The digital display device 190 is a device that can be configured by the interface application 110 to display, and/or project the user interface 135. Additionally, the digital display device 190 can be configured to display content 130 included as part of the user interface 135. In one embodiment, the digital display device 190 is a monitor and/or television. In another embodiment, the digital display device 190 is a projector and/or a touch screen.

As noted above, in rendering the user interface 135, the interface application 110 selects one of the user profiles 140 to be loaded as the user interface 135 in response to a user accessing the digital display device 190. A user profile 140 includes information and layout preferences corresponding to a user which has been registered with the machine 100. The user profile 140 can identify at least one from the group consisting of a background image to be used in the user interface 135, one or more icons to be included in the user interface 135, one or more content 130 to be included in the user interface 135, and a layout of one or more of the icons and one or more of the content 130 for the user interface 135.

Additionally, a user profile can be created and/or edited by a user accessing a webpage from the digital display device 190, the user accessing the webpage from another device, and/or the user accessing one or more input devices 150. In one embodiment, the user can access the webpage or one or more of the input devices 150 to specify which background image to be used for the user's interface, one or more icons to be included in the user's interface, one or more content to be included in the user's interface, and/or the layout of the icons and content.

Further, as illustrated in FIG. 1, a memory/storage device 180 coupled to the machine 100 can be utilized to store one or more of the user profiles 140. In another embodiment, one or more of the user profiles 140 are stored on another device and accessible to the interface application 110 through the network interface 160. Additionally, all of the user profiles 140 can be displayed by the interface application 110 as a list on the digital display device 190. In another embodiment, the interface application 110 additionally renders a user interface preview of one or more of the user profiles 140.

As noted above, one of the user profiles 140 can be selected in response to a user accessing the digital display device 190. In one embodiment, the user can access the digital display device 190 by manually accessing one or more input devices 150 coupled to the machine 100 and/or the digital display device 190. In another embodiment, the user can access the digital display device 190 in response to one or more of the input devices 150 detecting the user and interfacing with the user.

One or more input devices 150 are devices which can receive input and/or commands from the user. In one embodiment, one or more of the input devices 150 are input buttons which can be utilized by the user when the user is selecting one of the user profiles 140 to loaded as the user interface 135. Additionally, as noted above, one or more of the input devices 150 can detect when a user is present. One or more of the input devices 150 can utilize motion sensing technology to determine whether a user is present.

Further, one or more input devices 150 can be utilized by the user and/or the interface application 110 to authenticate the user. When authenticating the user, one or more of the input devices 150 can capture an image of the user and/or a voice of the user. The interlace application 110 can then utilize facial recognition technology and/or voice recognition technology to determine whether the user is registered with the machine 100. In another embodiment, the user can manually access one or more of the input devices 150 to enter a password or a pin when authenticating himself.

One or more of the input devices 150 can include at least one from the group consisting of a camera, a touch screen, a fingerprint scanner, a keyboard, a mouse, a microphone, and/or an input button. In one embodiment, one or more of the input devices 150 can be coupled to the digital display device 190 and/or coupled to the machine 100. In another embodiment, one or more of the input devices 150 can be integrated as part of the digital display device 190 and/or integrated as part of the machine 100.

Once a user profile 140 has been selected, the interface application 110 can proceed to utilize the information from the selected user profile 140 to render the user interface 135. When rendering the user interface 135, the interface application 110 extracts the information listed in the selected user profile 135 to determine which background image to utilize, which icons to include, which content 130 to include, and/or how to organize all of the icons and content. Additionally, when rendering the user interface 135, the interface application 110 identifies and loads one or more of the content 130 associated with the selected user profile 140.

One or more content 130 can include information, text, and/or media which the user specifies to be included in the user interface 135. In one embodiment, one or more of the content 130 can include at least one from the group consisting of one or more news sources, one or more stock sources, one or more weather forecast, one or more blogs, one or more web pages, and one or more media files. Additionally, one or more of the media files can include pictures, videos, and/or music. In other embodiments, one or more of the content 130 can include additional information, text, and/or media which the user wishes to view in the user interface 135.

As illustrated in FIG. 1, one or more of the content 130 can be stored on the memory/storage medium 180 coupled to the machine 100. In another embodiment, one or more of the content 130 is stored on another device, server, and/or web space and is accessible to the interface application 110 through the network interface 160.

The network interface 160 is a device coupled to the machine 100 which the interface application 110 can utilize to send and/or receive information, such as one or more content 130. In one embodiment, the network interface 160 establishes a physical connection with a device, server, and/or web space to retrieve the content 130. In another embodiment, the network interface 160 is a wireless device and retrieves the content 130 through a wireless connection,

Additionally, one or more of the content 130 displayed in the user interface 135 can be updated periodically when the device, server, and/or web space has indicated a change in one or more of the content or when new content becomes available. Once, the interface application 110 has retrieved the content 130, the interface application 110 can proceed to load the content 130 to be included in the user interface 110, The interface application 110 can then create the user interface 135 and organize a layout of the user interface 135 to include the background image, the icons, and the content 130 listed in the selected user profile 140.

In organizing the user interface 135, the interface application 110 will determine from the selected user profile where in the user interface 135 to place one or more of the icons. Additionally, the interface application 135 will determine where to place one or more of the content 130. Once, the user interface 135 has been created and organized, the interface application 110 will proceed to render the user interface 135 for display on the digital display device 190. In one embodiment, the user interface 135 can be updated to include new content, replace existing content, and/or modify existing content.

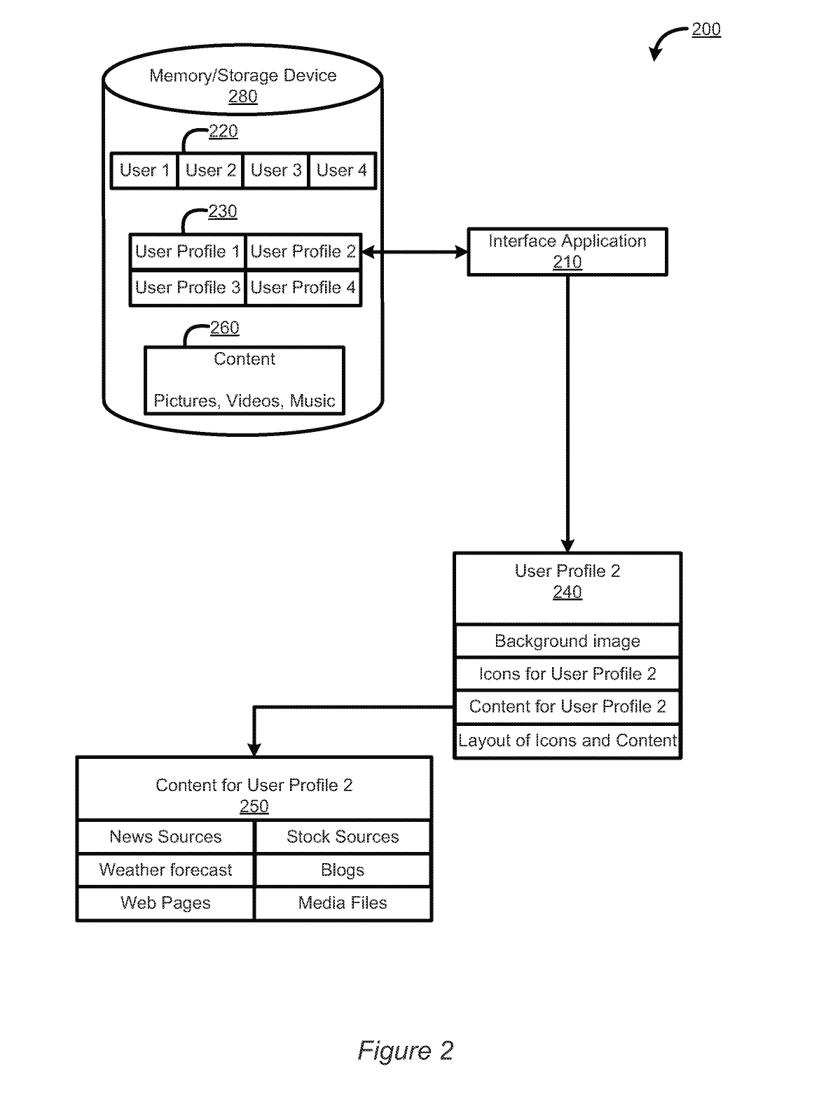

FIG. 2 illustrates a block diagram of an interface application 210 selecting a user profile 230 to be loaded as a user interface and identifying one or more content 250 associated with the user profile 240 according to an embodiment of the invention. As noted above, in one embodiment, the interface application 210 can be included in a machine 200.

Additionally, as noted above and illustrated in FIG. 2, one or more user profiles 230 can be stored on a memory/storage device 280 of the machine 200. In other embodiments, one or more of the user profiles 230 can be stored on additional devices which can be accessed by the interface application 210 through a network interface of the machine 200.

As noted above, the user profiles 230 can correspond to users 220 which have been registered with the machine 200. In the present embodiment, user profile 1 corresponds to user 1, user profile 2 240 corresponds to user 2, user profile 3 corresponds to user 3, and user profile 4 corresponds to user 4.

In one embodiment, in response to a user accessing a digital display device coupled to the machine 200, one of the user profiles 230 can be selected to be loaded as a user interface. Additionally, as noted above, a user profile 230 can be manually selected by a user accessing one or more input devices or automatically by the interface application 110 in response to the user 220 being authenticated.

As shown in FIG. 2, in one embodiment, user profile 2 240 has been selected by the interface application 210. As noted above, once a user profile has been selected, the interface application 210 proceeds to extract information from the selected user profile 2 240 to identify a background image to be used in the user interface, one or more icons to be used in the user interface, one or more content to be used in the user interface, and/or the layout of the icons and the content.

Additionally, as noted above and as illustrated in FIG. 2, when rendering the user interface, the interface application 210 additionally identifies one or more of the content associated with the selected user profile 2. As illustrated in FIG. 2, the interface application 210 identifies that the content of user profile 2 250 lists news sources, stock sources, a weather forecast, blogs, web pages, and media files. As a result, the interface will proceed to locate and load the identified news sources, stock sources, the weather forecast, blogs, web pages, and media files in the user interface.

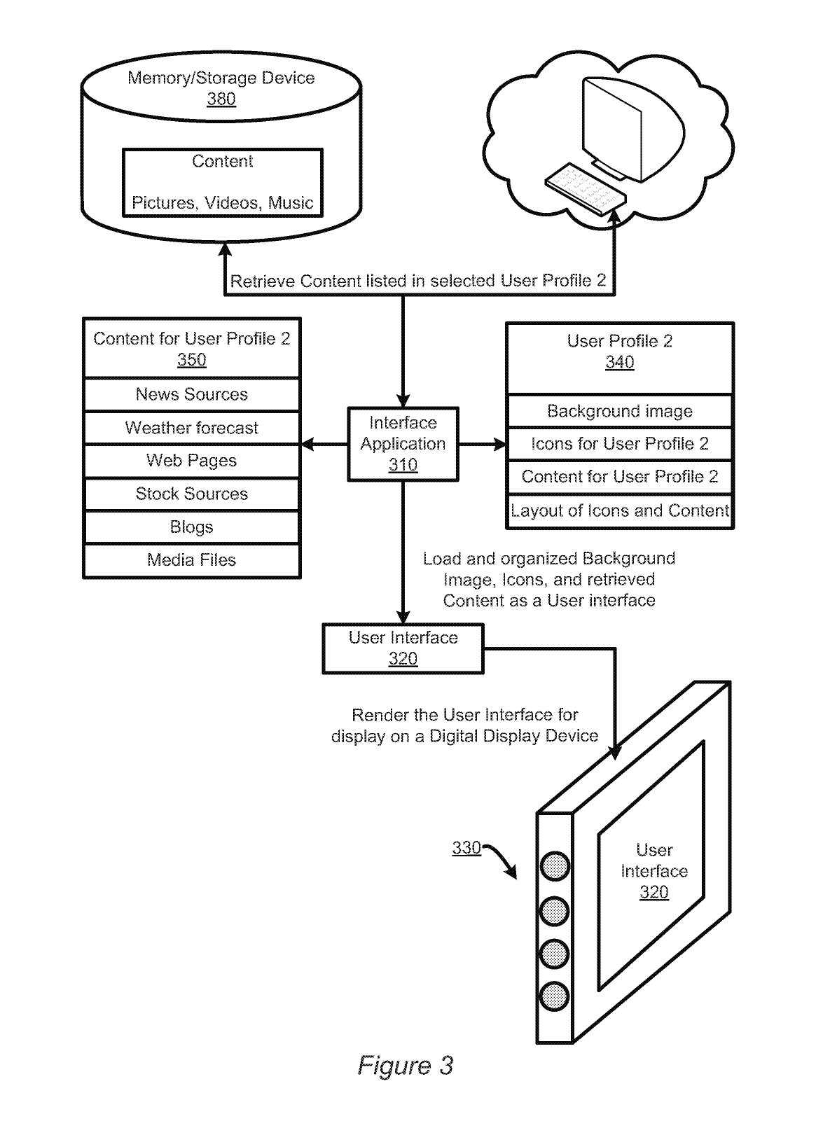

FIG. 3 illustrates a block diagram of an interface application 310 rendering a user interface 320 for display on a digital display device 330 in response to a selected user profile 340 according to an embodiment of the invention. As illustrated in FIG. 3, in one embodiment, the user profile 2 340 has been selected by the interface application 310 or a user accessing the digital display device 330.

Once user profile 2 340 has been selected, the interface application 310 proceeds to extract information from user profile 340 to create the user interface 320. As noted above, when creating the user interface 320, the interface application 310 identifies, loads, and organizes the background image, icons, and content 350 listed in user profile 2 340.

As noted above, in identifying and loading the content from user profile 2 340, the interface application 310 identifies the content 350 listed in user profile 2 340, As illustrated in FIG. 3, in the present embodiment, the interface application 310 identifies that the content 350 to be included in the user interface 320 includes news sources, a weather forecast, web pages, stock sources, blogs, and media files.

Once the interface application 310 has identified all of the content from user profile 2 340, the interface application 310 proceeds to retrieve the content 350. As illustrated in FIG. 3, in one embodiment, one or more of the content 350 for user profile 2 340 can be stored on a memory/storage device coupled to a machine where the interface application 310 is located. In other embodiments, one or more of the content 350 can be stored on additional devices and/or memory/storage devices accessible to the interface application 310 through a network interface of the machine.

When one or more of the content 350 is stored on additional devices accessible through the network interface, the interface application 310 can download the content 350 to be included in the user interface. In another embodiment, the interface application 310 streams one or more of the content 350. In other embodiments, the interface application 310 can update one or more of the content 350 in the user interface periodically or upon demand.

Once all of the content 350 has been identified and retrieved, the interface application will proceed to load the content 350 to be included as part of the user interface 320. As noted above, the interface application 310 can organize the background image, icons, and/or content 350 of user profile 2 340. As noted above, the interface application 310 can determine where on the user interface to place one or more of the icons. Additionally, the interface application 310 can determine where to place one or more of the content 350. The interface application 310 will then proceed to render the user interface 320 for display on the digital display device 330.

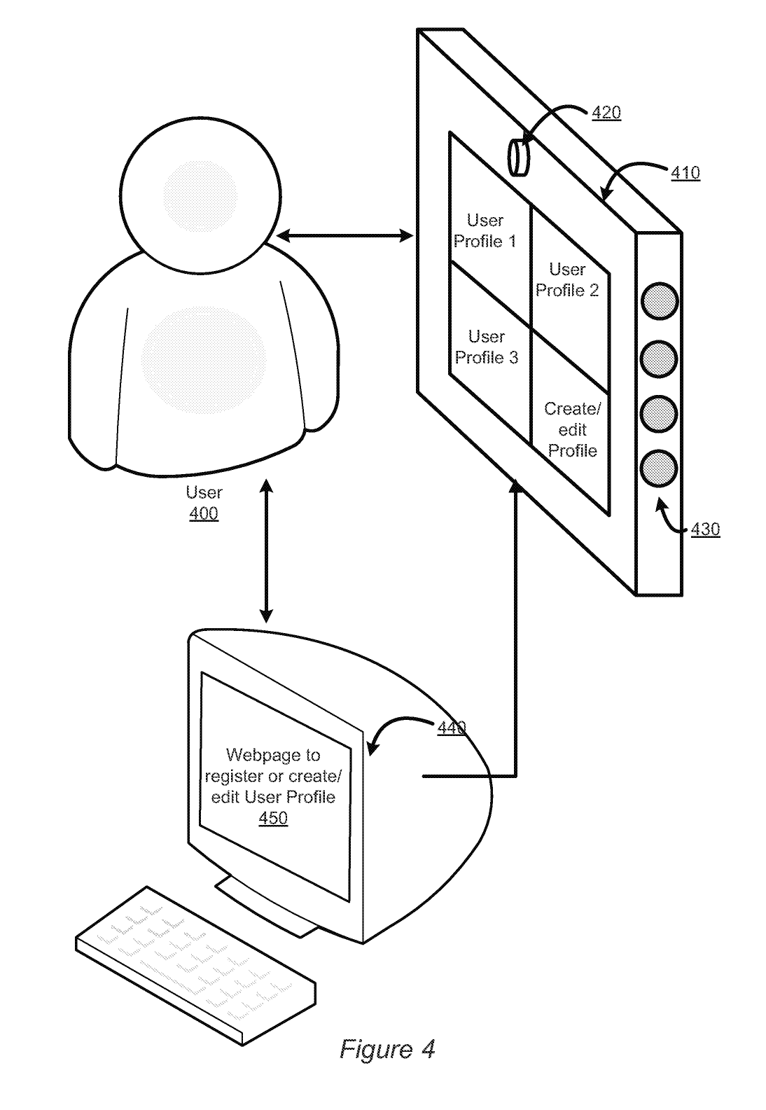

FIG. 4 illustrates a user 400 creating or editing one or more user profiles according to an embodiment of the invention. As noted above, the user 400 can access a digital display device 410 to select a user profile to be loaded as a user interface. Additionally, as noted above, an interface application can initially determine whether the user 400 accessing the digital display device 410 is registered with the machine before allowing the user 400 to select a user profile.

In determining whether the user is registered with the machine, the interface application can utilize one or more input devices 420, 430 to authenticate the user 400. In one embodiment, as illustrated in FIG. 4, one or more of the input devices 420 can be integrated as part of the digital display device 410. Additionally, one or more of the input devices 420 can be a camera. As illustrated in FIG. 4, the input device 420 can capture an image of the user 400 and proceed to utilize facial recognition technology to authenticate the user 400 and to determine whether the user 400 is registered with the machine.

In another embodiment, the user 400 can access one or more of the input devices 430 to authenticate himself. As noted above, one or more of the input devices 430 can be input buttons coupled to the digital display device 410 that the user 400 can access. In one embodiment, the user accesses one or more of the input devices 430 to enter a pin. If the user 400 cannot be authenticated, the interface application will determine that the user 400 is not registered with the machine and proceed to prompt the user 400 to register with the machine using one or more of the input devices 420, 430 and/or another device 440.

As noted above and as illustrated in FIG. 4, the user 400 can access a web page 450 from the digital display device 410 and/or another device 440. When accessing the web page 450, the user 400 can proceed to fill out user and/or profile information corresponding to the user 400 through one or more customization fields. Once the user 400 has finished filling out the user and/or profile information, the user and/or profile information can be saved and accessible to the machine. The user 400 is then registered with the machine. In other embodiments, the user 400 can access one or more input devices 420, 430 coupled to the digital display device 410 to register with the machine.

Once the user 400 has been registered and/or authenticated, the user 400 can proceed to create a new user profile or edit an existing user profile. Similar to registering with the machine, the user 400 can access one or more of the input devices 420, 430 to create and/or edit a user profile. Further, the user 400 can access the webpage 450 through the digital display device 410 and/or through the device 440 in order to create a new user profile or edit an existing user profile.

As illustrated in FIG. 4, the user 400 can also select one or more user profiles to be loaded as the user interface for the digital display device 410. As illustrated in FIG. 4, the user can utilize one or more of the input devices 420, 430 to select one or more user profiles to be loaded. In another embodiment, the interface application can automatically select a user profile to be loaded in response to authenticating the user 400.

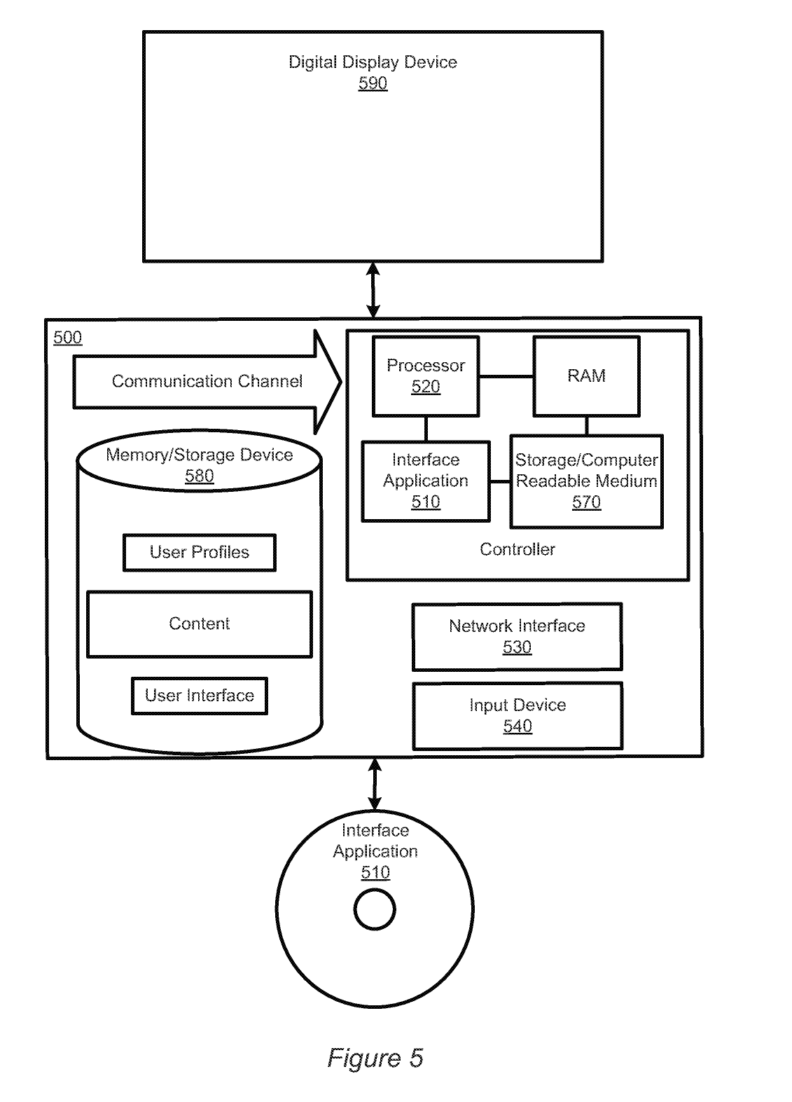

FIG. 5 illustrates a machine 500 with an embedded interface application 510 and an interface application 510 stored on a removable medium being accessed by the machine 500 according to an embodiment of the invention. For the purposes of this description, a removable medium is any tangible apparatus that contains, stores, communicates, or transports the application for use by or in connection with the machine 500. As noted above, in one embodiment, the interface application 510 is firmware that is embedded into one or more components of the machine 500 as ROM. In other embodiments, the interface application 510 is a software application which is stored and accessed from a hard drive, a compact disc, a flash disk, a network drive or any other form of computer readable medium that is coupled to the machine 500.

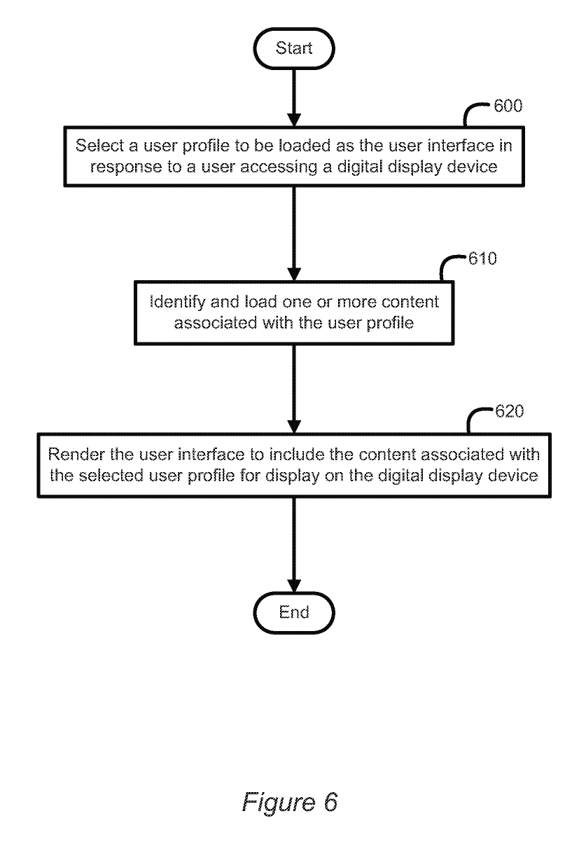

FIG. 6 is a flow chart illustrating a method for rendering a user interface according to an embodiment of the invention. The method of FIG. 6 uses a machine coupled to a digital display device, one or more input devices, a display application, one or more user profiles, and one or more content. In other embodiments, the method of FIG. 6 uses additional components and/or devices in addition to and/or in lieu of those noted above and illustrated in FIGS. 1, 2, 3, 4, and 5.

As noted above, an interface application of the machine can initially determine whether a user is accessing the digital display device. Additionally as noted above, the user can access the digital display device by manually accessing one or more input devices and/or buttons on the digital display device. In another embodiment, the user can be determined to be accessing the digital display device when one or more of the input devices detect a presence of the user. The interface application can then select a user profile to be loaded in response to the user accessing the digital display device 600.

As noted above, the user profile identifies at least one from the group consisting of a background image to be used as the interface, one or more content to be included and displayed in the user interface, one or more icons to be included and displayed in the user interface, one or more content to be included and displayed in the user interface, and a layout or organization of one or more of the icons and/or one or more of the content in the user interface.

Additionally, as noted above, the user can manually select one of the user profiles to be loaded by accessing the digital display device. The user can access one or more input buttons on the digital display device and/or the digital display device can display a list of user profiles available which the user can choose from.

In another embodiment, the interface application can configure one or more of the input devices to interact with user. One or more of the input devices can detect a voice prompt which specifies which user profile to select. Additionally, the interface application can utilize facial recognition technology and/or voice recognition technology to authenticate the user and choose a user profile which corresponds to the authenticated user.

Once the interface application has selected a user profile to be loaded, the interface application will proceed to build and organize the layout of the user interface to include the background image and the icons listed in the user profile. Further, the interface application will proceed to identify and load one or more of the content associated with the user profile 610.

As noted above, when identifying one or more of the content, the interface application accesses the user profile and identifies content listed in the user profile. As noted above, the content can include at least one from the group consisting of one or more news sources, one or more stock sources, one or more weather forecast, one or more blogs, one or more web pages, and/or one or more media files.

Further, once the content has been identified, the interface application can proceed to retrieve the content. In one embodiment, one or more of the content is stored on a memory/storage device coupled to the machine. In another embodiment, one or more of the content is stored on additional devices accessible to the interface application through a network interface on the machine.

When the content is stored on the additional devices accessible through the network interface, the interface application can download the content to be included in the user interface. In another embodiment, the interface application can stream the content to be included in the user interface.

Once the content associated with the user profile has been loaded and included as part of the user interface, the interface application can proceed to create the user interface and organize the user interface. As noted above, in organizing the user interface, the interface application can determine whether to position one or more of the icons in the user interface. Additionally, the interface application can determine where to position one or more of the content in the user interface.

Once the interface application has created and organized the user interface, the interface application will proceed to render the user interface with the content associated with the selected user profile for display on the digital display device 620. The method is then complete or the interface application can determine when a user is accessing the digital display device and proceed to select a user profile to render for display on the digital display device. In other embodiments, the method of FIG. 6 includes additional steps in addition to and/or in lieu of those depicted in FIG. 6.

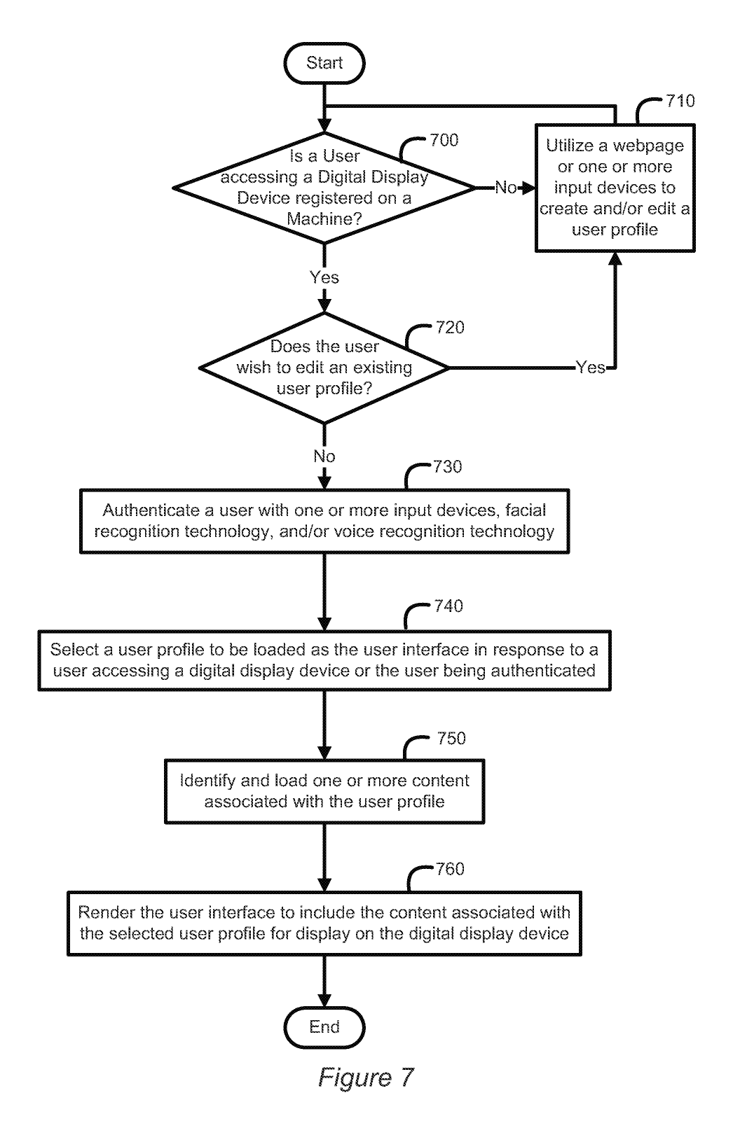

FIG. 7 is a flow chart illustrating a method for rendering a user interface according to another embodiment of the invention. Similar to the method of FIG. 6, the method of FIG. 7 uses a machine coupled to a digital display device, one or more input devices, a display application, one or more user profiles, and one or more content. In other embodiments, the method of FIG. 7 uses additional components and/or devices in addition to and/or in lieu of those noted above and illustrated in FIGS. 1, 2, 3, 4, and 5.

As noted above, an interface application initially utilizes one or more input devices to determine whether a user is accessing the digital display device. If the user is accessing the digital display device, the interface application will proceed to determine whether the user is registered on the machine 700. As noted above, the user is registered with the machine if one or more user profiles on the machine corresponds to the user.

If the interface application determines that the user is not registered on the machine, the user can utilize a webpage or one or more input devices to create a user profile 710. As noted above, the user can access the webpage from the machine, the digital display device, and/or another device. In another embodiment, the interface application can configure the digital display device to display a message prompting the user to create a user profile.

If the interface application finds a corresponding user profile for the user and determines that the user is registered on the machine, the interface application can additionally determine whether the user wishes to create a new user profile or edit the an existing user profile 720. As noted above, the user can utilize a webpage or one or more input devices to create and/or edit a user profile 710,

If the user does not wish to create and/or edit an existing user profile, the interface application can proceed to authenticate the user with one or more input devices, facial recognition technology, and/or voice recognition technology 730. As noted above, in one embodiment, the user can access one or more of the input devices to enter a password or pin code to authenticate himself. In another embodiment, one or more input devices can capture an image of the user's face and scan for a matching image registered on the machine. In other embodiments, one or more of the input devices can capture a voice from the user and proceed to scan for a matching voice.

Once the user has been authenticated, a user profile can be selected and loaded as a user interface for the digital display device 740. As noted above, the user profile can manually be selected by the user or the user profile can be automatically selected by the interface application in response to authenticating the user. Further, when loading the user interface, the interface application can identify a background image to be used as the background of the user interface. Additionally, the interface application can identify one or more icons to be included in the user interface. Further the interface application can identify and load one or more content associated with the user profile as part of the user interface 750.

As noted above, one or more of the content can be stored on a memory/storage device coupled on the machine. Additionally, one or more of the content can be stored on additional devices accessible to the user interface through a network interface. As noted above, when the content is stored on the additional devices accessible through the network interface, the interface application can download or stream the content to be included in the user interface.

Once the content has been identified and loaded as part of the user interface, the interface application can create and organize a layout of the user interface. As noted above, the interface application can determine where to position one or more of the icons and determine where to position one or more of the content. The interface application can then render the user interface to include the content associated with the selected user profile for display on the digital display device 760.

The method is then complete or the interface application can continue to load one or more selected user profiles and render the user interface to include content associated with the user interface when a user accesses the digital display device. In other embodiments, the method of FIG. 7 includes additional steps in addition to and/or in lieu of those depicted in FIG. 7.

By identifying a user and selecting a user profile in response to the user accessing a digital display device, a customized user interface for the user can be rendered for display on the digital display device. As a result, a more convenient and user friendly experience can be created for the user when viewing the digital display device. Additionally, by identifying one or more content associated with the user profile, retrieving the content, and rendering the user interface to include the content, a more personalized viewing experience can be created for the user.

What is claimed is:

1. A method for rendering a user interface comprising:
selecting a user profile to be loaded as the user interface in response to a user accessing a digital display device;
identifying and loading one or more content associated with the user profile; and
rendering the user interface to include the content associated with the selected user profile for display on the digital display device.

2. The method for rendering a user interface of claim 1 wherein the user profile identifies at least one from the group consisting of a background image to be used in the user interface, one or more icons to be included in the user interface, one or more content to be included in the user interface, and a layout of the icons and the content to be included in the user interface.

3. The method for rendering a user interface of claim 2 wherein one or more of the content includes at least one from the group consisting of one or more news sources, one or more stock sources, one or more weather forecast, one or more blogs, one or more web pages, and one or more media files.

4. The method for rendering a user interface of claim 1 further comprising determining whether to create a new user profile or edit the user profile.

5. The method for rendering a user interface of claim 4 wherein the new user profile and the user profile can be created or edited by at least one from the group consisting of the user accessing a webpage from the digital display device, the user accessing the webpage from another device, and the user accessing one or more input devices coupled to the digital display device.

6. The method for rendering a user interface of claim 1 further comprising authenticating the user with one or more input devices.

7. A machine comprising:
a processor;
a digital display device configured to display a user interface;
one or more input devices;
an interface application executable by the processor from a storage medium and configured to identify and load one or more content associated with a selected user profile and render the user interface on the digital display device to include the content associated with the selected user profile.

8. The machine of claim 7 further comprising a storage device configured to store at least one from the group consisting of one or more user profiles and one or more of the content associated with the selected user profile.

9. The machine of claim 8 wherein one or more users are registered with the machine and the users are associated with one or more of the user profiles.

10. The machine of claim 7 further comprising a network interface configured to retrieve at least one from the group consisting of one or more user profiles and one or more of the content associated with the selected user profile.

11. The machine of claim 7 wherein one or more of the input devices include at least one from the group consisting of a camera, a touch screen, a fingerprint scanner, a keyboard, a mouse, a microphone, and a input button.

12. A computer-readable program in a computer-readable medium comprising:
an interface application configured to select a user profile to be loaded as a user interface in response to a user accessing a digital display device;
wherein the interface application is additionally configured to load one or more content identified to be associated with the user profile; and
wherein the interface is further configured to render the user interface for display on the digital display device to include the content associated with the selected user profile.

13. The computer-readable program in a computer-readable medium of claim 12 wherein the user can access one or more input devices coupled to the digital display device to select one of the user profiles to be rendered as the user interface.

14. The computer-readable program in a computer-readable medium of claim 12 wherein the interface application is additionally configured to authenticate the user accessing the digital display device with facial recognition technology or voice recognition technology.

15. The computer-readable program in a computer-readable medium of claim 14 wherein the interface application is further configured to select the user profile to be loaded as a user interface in response authenticating the user.
